(19) United States
(12) Patent Application Publication
(10) Pub. No.: US 2013/0098960 A1
(43) Pub. Date: Apr. 25, 2013

(54) Purse baby - secures your purse in an automobile passenger seat. Preventing the purse from falling on the floor when turning sharply or slamming on breaks

(71) Applicant: Tamika N. Bowman, Summerville, SC (US)

(72) Inventor: Tamika N. Bowman, Summerville, SC (US)

(21) Appl. No.: 13/373,894

(22) Filed: Jan. 17, 2012

Related U.S. Application Data
(60) Provisional application No. 61/627,847, filed on Oct. 19, 2011.

(51) Int. Cl. B60R 11/00

(52) U.S. Cl. 224/572

(57) ABSTRACT

The Purse Baby or Front Seat containment apparatus is used for containment of items such as: handbags, wireless tablets, files, books, other shopping bags, and the like. The apparatus which may be extended therefrom to rest on a surface of an automobile seat and the like. The cargo netting apparatus may be positioned at an upright angle relative to the supporting surface so as to maintain a level position. More specifically, the front panel assembly/front seat apparatus includes a nylon cargo netting portion, left back nylon strap portion connected to the back right nylon strap. A lock assembly is connected between the left back panel and the right back panel assembly for flexibility of the nylon cargo netting with respect to the back panel assembly. The top back panel portion of the back panel assembly includes a top back-panel connector portion.

### BACKGROUND OF THE INVENTION

1. Field of the Invention

The present invention relates generally to a containment apparatus for the automobile.

2. Description of the Prior Art

Nylon Cargo Netting is well known in the art. In addition, VELCRO™, has been known as a strap attachment and arranged to releasable secure and other types of removable articles securely yet removably in quick release manner onto supporting articles.

A patent of interest is U.S. Pat. No. 6,866,453 (Cargo Net) which may be attached to a vehicle seat is adapted to pivot between an extended position where it is connected by using U.S. Pat. No. 7,963,427 (Velcro).

Thus, while the foregoing body of prior art indicates it will be well known to use as containment apparatus which has the following combination of desirable features: (1) handbag containment, (2) file containment, (3) wireless tablet containment, (4) any bag of measurable size and (5) sunglasses. The foregoing desired characteristics are provided by the unique design of the nylon cargo netting apparatus of the present invention as will be made apparent from the following description thereof. Other advantages of the present invention over the prior art will be rendered evident.

### SUMMARY OF THE INVENTION

To achieve the foregoing and other advantages, the present invention, briefly described, provides a containment apparatus which includes a front panel assembly (nylon cargo netting) connected to the back panel portion. The front panel (containment apparatus) includes three connector portions (nylon straps) that assemble to the apparatus with VELCRO™. The strap assembly is foldable with respect to the containment apparatus.

A pair of linkage assemblies, VELCRO™, is connected between the back panel assemblies. Each of the linkage assemblies includes a link member, a first linger strap connected between the link member and the back panel assembly, and a second linker hinge connected between the link member and the front panel assembly. The back panel assembly has back-panel width, such that the containment apparatus assembly is nested in respect to the back panel assembly.

A flexible nylon apparatus, comprising an assembly which includes cargo netting apparatus connected by nylon straps, wherein said left back panel assembly includes a nylon strap connector portion for connecting said nylon cargo netting apparatus or a containment element therefore, and; wherein said top front panel-to-container connector portion is a top connector bar defined by a nylon strap.

The apparatus including a pair of linkage assemblies connected between said front panel assembly and said nylon strap panel assembly.

The apparatus of said linkage assemblies includes VELCRO™ a first linker connected between said link member and said back panel assembly, and a second linker (VELCRO™) connected between said link member and said nylon strap panel assembly.

The apparatus of said nylon cargo netting panel support portion includes three (3) nylon straps, said back-panel-connector portion includes a pair of complementary nylon strap panels, and inter fit with said nylon back panel is oriented at a horizontal orientation with respect to said back panel assembly.

The apparatus of claim a connector assembly between said left back panel and right back panel for retaining said nylon cargo netting assembly, said back panel assembly further includes a transverse portion which extends horizontally from a distal portion of said back panel assembly in a direction toward said front assembly, said nylon cargo netting includes top straps for connection to back panel to include a bottom strap for connecting.

The above brief description sets forth rather broadly the more important features of the present invention in order that the detailed description thereof that follows may be better understood, and in order that the present contributions to the art may be better appreciated. These are, of course additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF DRAWINGS

The invention will be better understood and the above objects as well as objects other than those set forth above will become more apparent after a study of the following detailed description thereof. Such description makes reference to the annexed drawing wherein:

FIG. 1 is a perspective view showing a preferred embodiment of the nylon cargo netting apparatus of the invention.

FIG. 2 is a rear view of the embodiment of the nylon straps shown in FIG. 1.

FIG. 3 is a free-standing view of the embodiment of the cargo netting containment apparatus (front view) and the nylon straps with VELCRO™ Linkage.

FIG. 4 is an enlarged side view of a free-standing nylon cargo netting apparatus of the invention

### DESCRIPTION OF THE PREFERRED EMBODIMENT

With reference to the drawings, a nylon cargo netting apparatus embodying the principles and concept of the present invention will be described.

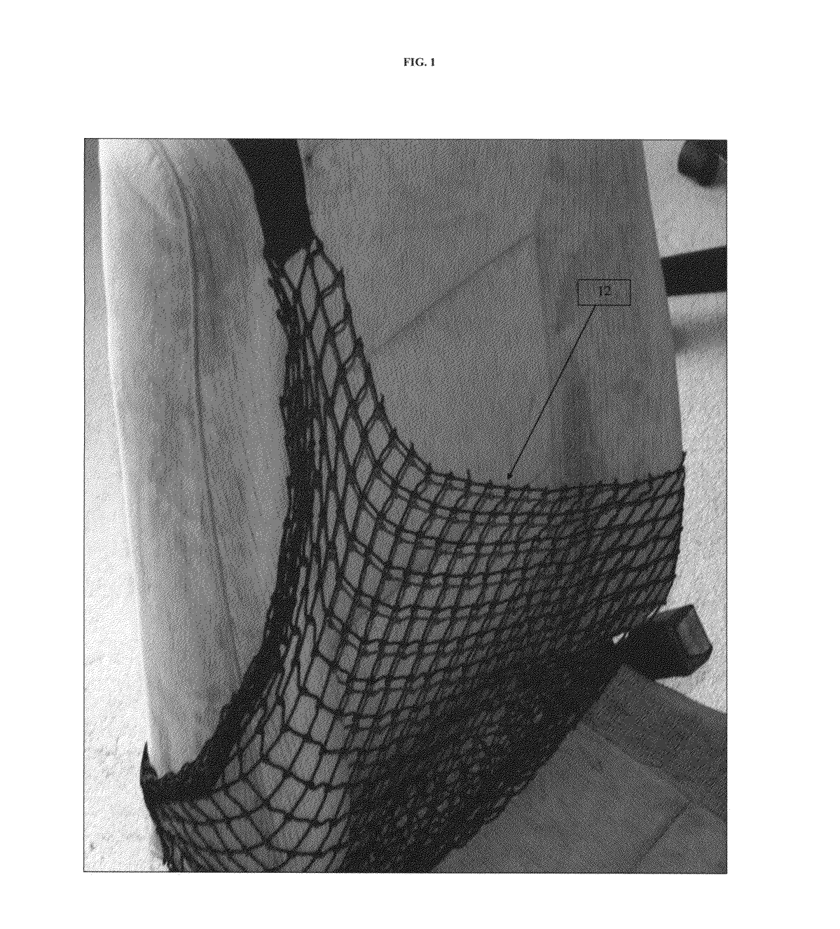

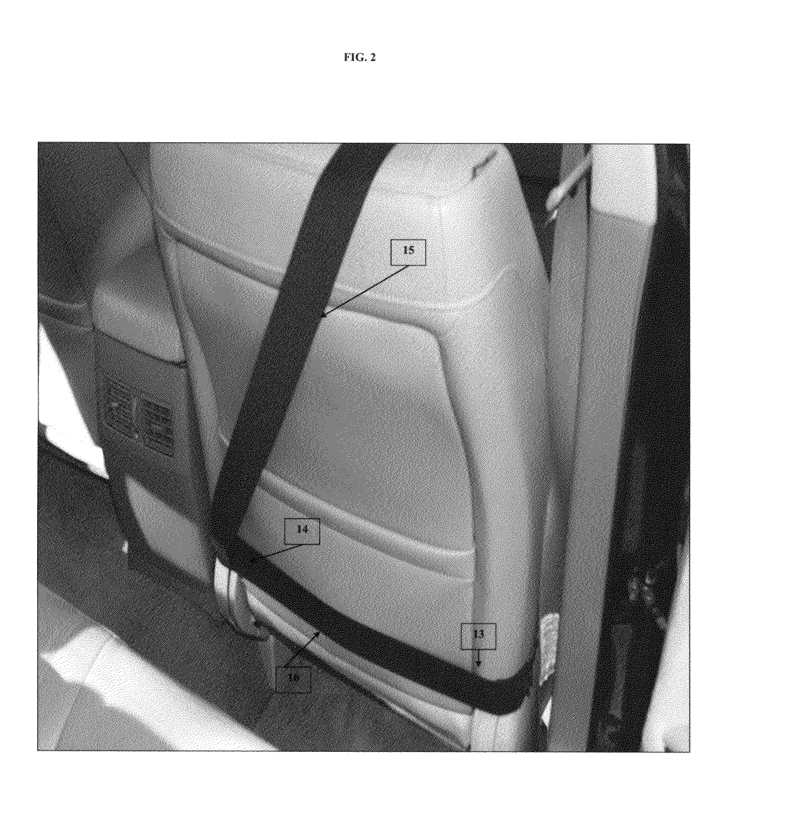

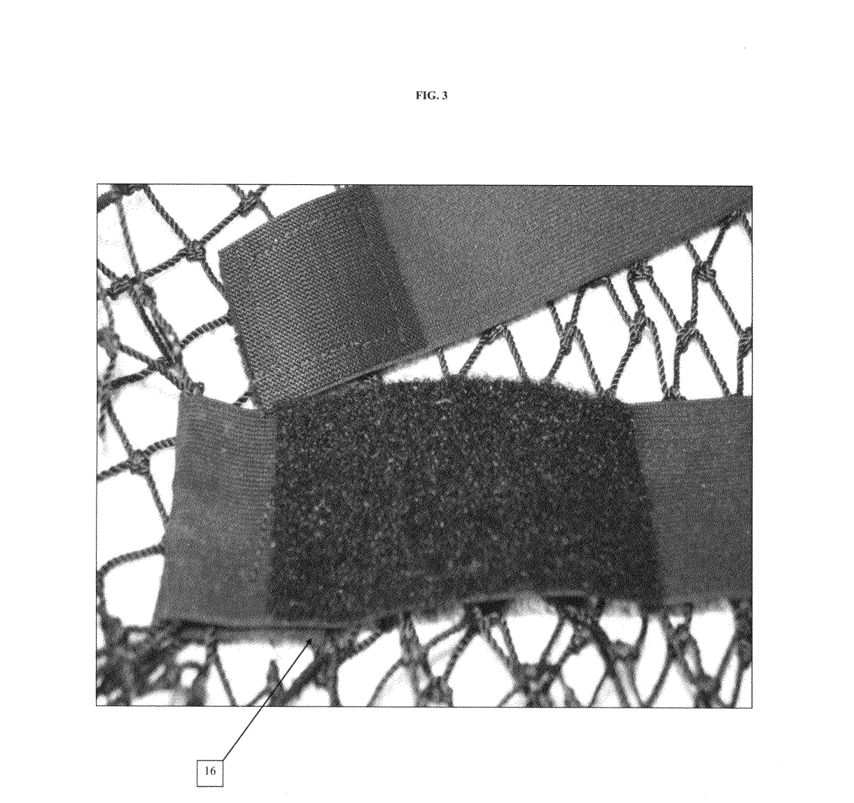

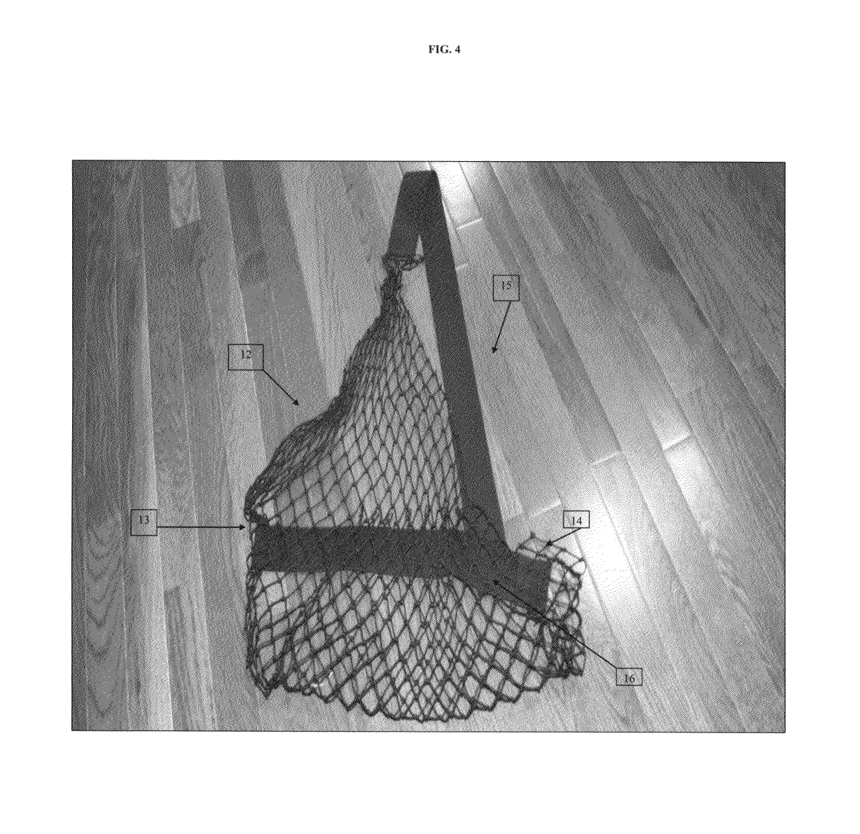

Turning to FIGS. 1-4, there is shown an exemplary embodiment of the nylon cargo netting apparatus (12) of the invention generally designated by reference numeral 12. In its preferred form, the nylon cargo netting apparatus (12) includes the VELCRO™ connector (16), 3 nylon straps for the right back panel (13), left back panel (14) and top panel (15). Generally the numbers begin with numeral 1, but note that FIGS. 1-4 will not reference numbers 1-11; they will begin with number 12.

Pair of linkage assemblies are connected between the left back panel (14) and right back pane (15). Each of the linkage assemblies includes a link member (VELCRO™) (16), a first linker hinge connected between the link member (13, 14).

Still a further object of the present invention is to provide a new nylon cargo netting apparatus which has an access opening at the side of the nylon cargo netting.

In accordance with another aspect of the present invention, as shown in FIGS. 1-4, a nylon cargo netting apparatus (12) includes nylon straps (13, 14, and 15). The left back panel (14) and right back panel (13) include complementary hook and loop connection material, such as VELCRO™ (16), for affixing the top straps (15) to the nylon cargo netting apparatus (12).

It is apparent from the above that he present invention accomplishes all of the objects set forth by providing a new nylon cargo netting containment apparatus that is low in cost, relatively simple in design and operation. With the invention, a nylon cargo netting containment apparatus is connected to the right back panel, left back panel and top panel simultaneously.

Thus while the present invention has been shown in the drawings and fully described above with particularity and detail in connection with what is presently deemed to be the most practical and preferred embodiment (s) of the invention. It will be apparent to that ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that he purposed o the foregoing Abstract provided at the beginning of this specification is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to scope of the invention in any way.

What is claimed as being new and desired to be protected by Letters Patent of the United States is as follows:

1. A flexible nylon apparatus, comprising:
an assembly which includes a cargo netting apparatus connected by nylon straps, wherein
said left back panel assembly includes a nylon strap connector portion for connecting said
nylon cargo netting apparatus or a containment element therefore, and;
wherein said top front panel-to-container connector portion is a top connector bar defined by a nylon strap

2. The apparatus of claim 1, further including:
a pair of linkage assemblies connected between said front panel assembly and said nylon strap panel assembly

3. The apparatus of claim 2 wherein each of said linkage assemblies includes VELCRO™, a first linker connected between said link member and said back panel assembly, and a second linker (VELCRO™) connected between said link member and said nylon strap panel assembly

4. The apparatus of claim 1 wherein:
said front panel assembly has front panel width, said nylon cargo netting width is more than said back panel width, such said left front panel assembly is nested within said back panel assembly when said nylon cargo netting panel assembly is flexed with respect to said back panel assembly.

5. The apparatus of claim 1 wherein:
said nylon cargo netting panel support portion includes three (3) nylon straps, said back-panel-connector portion includes a pair of complementary nylon strap panels, and inter fit with said nylon back panel is oriented at a horizontal orientation with respect to said back panel assembly.

6. The apparatus of claim 3, further including:
a connector assembly between said left back panel and right back panel for retaining said nylon cargo netting assembly,
said back panel assembly further includes a transverse portion which extends horizontally from a distal portion of said back panel assembly in a direction toward said front assembly,
said nylon cargo netting includes top straps for connection to back panel to include a bottom strap for connecting.
